(19) United States
(12) Patent Application Publication
(10) Pub. No.: US 2015/0033105 A1
(43) Pub. Date: Jan. 29, 2015

(54) System and Method of translation management, including concurrent user-directed presentation and execution of normalised and Romanised function and function parameter names, within Microsoft Excel for Windows (Excel) for non-English and non-Roman script languages.

(71) Applicants: Diarmuid Pigott, Nedlands (AU); Stephen Poulson, East Fremantle (AU)

(72) Inventors: Diarmuid Pigott, Nedlands (AU); Stephen Poulson, East Fremantle (AU)

(21) Appl. No.: 13/699,686

(22) PCT Filed: May 25, 2010
(86) PCT No.: PCT/AU2010/000637

§ 371 Date: Oct. 14, 2014

(51) Int. Cl. G06F 17/28; G06F 17/30

(52) U.S. Cl. CPC G06F 17/289; G06F 17/30734; G06F 17/30312
USPC 715/212

(57) ABSTRACT

A method to create and to permit multilingual cell formulas to be written and translated concurrently into any human language within Microsoft Excel, including those that are not representable in ANSI. This method enables multiple ad-hoc concurrent semantically complete and extensible non-Roman and non-English natural language function sets and function names available for presentation and execution within cell formulas within MS Excel and to provide real-time translation of presentation and execution between nominated language function sets. This process provides for a user-directed in-cell language nomination for the presentation and execution as well as the direction and target of the in-cell translation

### TECHNICAL FIELD

The present invention relates in general to the field of spreadsheet applications, and in particular to particularly Microsoft Excel for Windows.

### BACKGROUND ART

As an introduction to the Add-in system for Microsoft (MS) Excel, it is essential that a basic understanding of Excel's infrastructure is understood. The Excel application is a spreadsheet application that provides grids/arrays of cells in a Worksheet format that are boxes into which data or formulae can be entered. The spreadsheet application executes mathematical and textual based functions for end users. It does this by executing functions [that comply with the Code Page] contained within cells, that refer to other cells. So one function in one cell may add up a range of cells and show the result of those cells within the cell that contains the formula, e.g. (=SUM(D5:E7)). Cells may be referenced by their Cell Address (e.g., “D5” for the 5th cell down in the 4th column) or as ranges (e.g., “D5:E7”, all cells from the 5th cell down in the 4th column until the 7th cell down in the 5th column, equaling 6 cells). Ranges of cells can be named for easier integration into formula as well. In Windows, so named Code Page [ACP] or encoding means; Windows-1252 Code Page (common to Western users), any installed Windows Code Page mentioned in the

HKEY_LOCAL_MACHINE\SYSTEM\CurrentControlSet\Control\Nls\CodePage\ACP registry key

Extending Excel Function base. Excel currently comprises more than 300 functions that provide a multitude of services which are executed by Excel's internal calculating engine. If that is not enough for the end user, the end user can extend Excel's functionality locally by writing User Defined Functions (UDFs) in a programming language called Visual Basic for Applications (VBA) within the Excel Application. These UDF are executed by the VBA interpreter. In additional, the user can extend their useable function set by installing externally created software components called Add-ins. Therefore, Excel utilises more than 1 source to reference executable functions for an end users' ability to control functionality. The Excel Application enforces strict rules of permission when determining which source of functions it will execute at which time. This is done for many reasons, including prevention of ambiguity, prevention of catastrophic failure and/or prevention of endless loops. This results in the user being able to access either the Excel internal calculating engine, UDFs or functions from the Add-ins. The Add-ins include Excel Add-in files (XLA) and/or compliant Component Object Model add-ins (COM). All functional source code developed within the COM required development in an external development environment specifically for making COM DLLs. End users can locally extend Excel's functionality by writing UDFs using Excel's VBA programming editor. This editor can be accessed from all Excel workbooks. Excel's main user interface is divided into 2 main areas. First, the workbook interface and secondly the worksheet interface. A workbook can contain 1 or more worksheets. These worksheets are the main entry point that users input data and formulas. End users can also develop functional source code in an external development environment for making COM DLLs.

Excel VBA programming editor and External COM development environment, The Excel VBA programming editor may comprise 4 main programmatic sections. Each section is used for different purposes. First, the Excel Object section comprises a single Workbook Module and a Worksheet Module for each worksheet. Both of these types of modules are empty until the user intentionally adds UDFs into them. UDFs that are entered into the Workbook module are available from any point within that workbook. UDFs that are entered into the individual Worksheet modules are available only within the specifically related worksheet. Second, the Form section is used to create entry and dialogue screens for interaction with the user. Third, the Modules section is used to create and store Module Components such as sub-routines, functions, public variables, function declarations and properties. Function declarations are pointers to external libraries. Lastly, the Class Modules section is used to create and store Objects. These Objects comprise methods and/or properties. External COM development environments are available for many languages but their functionality is linked to the Excel Runtime Object Table.

Excel Runtime Object Table (ROT), As a brief introduction to the infrastructure and hierarchy of permission of the Excel application that utilises these programmatic sections, it may be described as follows. Shortly after the Excel application starts, a Runtime Object Table (ROT) complete with Excel's native function tokens identified as tokens, (according to the locale and language version of Excel) is loaded into in Excel's working memory. The locale of the operating system of the user's computer includes the combination of settings of the country, language, Code page and keyboard. The Excel application then loads all of the Add-ins that the user has selected to be loaded and then all of those function tokens from the Add-ins are added to the ROT. All Excel function tokens, UDF's and Ranges with names within the ROT at any given time are said to be “in-scope”. As each individual workbook is brought into focus, the names of the UDFs contained with that Workbook's Module are also loaded into the ROT. At the same time, any Named Ranges within the Workbook are added to the ROT. Named ranges are groups of the cells in a Worksheet that have been given a name that they can be referenced by. Furthermore, when each individual Worksheet is brought into focus, the names of the UDFs contained within that Worksheet's Module are also loaded into the ROT. When a user moves between the worksheets in current workbook, the previously “in focus” Worksheet UDFs are removed from the ROT and the currently “in focus” Worksheet's names of the UDFs are added to the ROT. When a new Workbook is brought into focus, the existing names of the UDF's and Named Ranges from the previously “in-focus” Workbook and Worksheets are removed from the ROT and the new Workbook's and Worksheet's names of the UDFs and Named Ranges are added to the ROT. So the ROT is continually switching in and out function tokens and Named Ranges from the different levels as the focus changes within the Excel application. Therefore, essentially the ROT only stores the function tokens and Range Names as pointers to their sources. Excel imposes its hierarchy of permission on each function token and Range Name depending on its source. As a result of this, UDF's and Range Names are only directly accessible to the current Workbook in focus, but Add-in functions are available in any Workbook or Worksheet as they operate at the application level, rather than the workbook or worksheet level. Strict rules of permission mentioned above are enforced according to Excel's hierarchy of permission. Basically, all of the native Excel functions are executed by the internal Excel calculating engine and all of the UDFs (non-native functions) in-scope are executed by the VBA interpreter. The VBA interpreter also provides an internal addressable memory space. This VBA memory space provides for memory variables (Variables). Variables are stored values coded in VBA within the Workbook's Module for access by name for any or all of the UDFs within the Workbook's Module. They are not available for direct reference or calculation from the spreadsheet cells.

Excel, one language at a time, At present, there are currently 14 language versions of Excel available for purchase. Functionally, the native Excel function tokens provided by the Excel application are available for presentation and execution according to the combination of the locale settings of the user's computer and the language of the Excel version. Therefore the user is restricted to use only a single set of native Excel function tokens that are bound to the locale. The locale controlled native Excel function tokens are considered to be early binding and therefore are set for the duration of the application's life within the environment of the system's locale. So when the Excel application is started, the user has no control over the Excel's language of presentation from that point onwards, or indeed the function tokens themselves within the formulas or how they are presented or executed. So effectively, the native Excel function tokens, UDF's and Range names can only be made up from the limited set of characters available in the Code Page, according to the locale. As an example of Excel's automatic translation of formula, if a German version of Excel was installed in a French operating system locale, all of the function tokens within an open spreadsheet would be presented according the English function token set. No German or French function tokens would be available for execution. On the other hand, if the same German version of Excel was installed in a German operating system locale, all of the function tokens within an open spreadsheet would be presented according the German function token set. No English functions would be available for execution. The user has no control over the presentation or language of execution. This means that there is no choice about what presentations the formulas have. Moreover, when a spreadsheet goes from a machine set in one Code Page to a machine set in another, the formula changes automatically. That means the spreadsheet user has no control over the language they are using.

Excel Formula Execution Process, So when an end user of Excel enters a function token into a cell, it must be within the function token set of the language that the operating system's locale and of the Install Excel language version. Excel begins the process to execute the function token. In basic terms, the process is as follows;
Entry of a formula, which comprises one or more sub-expressions is
   conducted by the end user whom then presses the Enter key to begin the processing the formula. The formula is similar to an everyday algebraic expression which consists of a series of tokens, including function tokens, range names and values (Dates, Numbers, Currency, Percentage, Strings, Booleans), all grouped by parenthesis as well as arithmetic symbols (+, −, =, / , *, ̂). Subexpressions are distinct components bound by opening and closing parenthesis that are themselves executable formulae
   MS Excel's calculation engine (CE) evaluates the formula. The process that is generally accepted to be taking place is as follows as Excel is black boxed. The parser of the internal calculating engine;
      analyses the formula to see if it well formed, (every open quote has a close quote, every open bracket has a close bracket, every arithmetic expression is a singleton and occurs in the correct position). If it is not well formed, the parser generates an error which is presented to the user in a dialogue box. If it is well formed, it then
      Analyses the formula and identifies all sub-expressions through the use of opening and closing parenthesis.
      Analyses the sub-expression to identify all of the tokens within them. It does this in the following order, identifying which tokens are;
         Native Excel values
         Cell-References
         Native Excel function tokens.
         Named Ranges defined in the current workbook that are therefore are within the ROT.
         (This is the last step of successful native Excel token matching.)
         Names of the UDFs that are therefore are within the ROT
         Names of the Add-in functions that are within the ROT
      At the end of this process
         if any tokens remain unidentified, a “#Name?” error symbol is presented in the cell.
         if all tokens are successfully identified during the evaluation process of the formula, the Excel infrastructure then begins the cyclical sub-expression evaluation and execution process. This process starts an allorecursive process that targets the inner most sub-expression until the entire set of sub-expressions within the formula have been substituted and executed. As the inner most subexpression is evaluated, next inner most sub-expression becomes the inner most subexpression. This happens until exhaustion of the formula. From the starting point, the parser evaluates the Named Ranges and the Cell References by substituting their tokens with the values from the source that they point to. It then executes the native Excel function, UDFs and/or add-in functions within the sub-expression together with those substituted values. Thereafter, the next inner most subexpression is executed following its own substitution process.

### DISCLOSURE OF INVENTION

### Technical Problem

Excel permits only a subset of ANSI characters (upper and lower case Roman) to be used in the formula bar, based on the user's operating system locale and Code Page. (Those 14 languages that are supported are limited to the Code Page character sets of the user's operating system locale and Code Page, and are invoked automatically on detection of the Code Page.) Up until to now, there has been no control for the user to choose the language of display or presentation of function tokens when using Excel as these are automatically invoked by the Excel application from the locale and Code Page. Because of this, users are forced to use which ever function token set the locale and Code Page determine, be it German, English or French. So a German, using a French operating system and German Excel version would have function tokens presented to him in English. Or if the operating system was German, the function tokens would be presented in German.

For the past few decades, the number of Excel languages has remained fairly static for one reason or another as the addition of an extra language set to Excel would require reengineering the Excel calculating engine for each language proposed. This may well be not be warranted because of the complexity and cost involved in return for the limited number of sales for most human languages. This renders the great majority of the world's potential users incapable of controlling Excel using their native language. So creating financial plans, models or performing bookkeeping tasks with the program is several orders of magnitude more difficult for those people than English speakers, unless they are willing to shoulder the additional burden of learning business English. Even when a degree of mastery of business English is acquired, there remains a component of cognitive dissonance in the use of non-native formulae. Having spreadsheet cell formulae in a user's native language would have the benefit of removing this cognitive gap: making them more rapidly understood, better remembered, more easily utilised and more simply explained

### Technical Solution

The key difference between today's Excel application and this invention is that this invention relies on the complete separation of function token set display and execution from the operating system locale and Code Page. This invention invokes its own auxiliary calculating engine in many cases and provides concurrent access to multiple language function tokens. By providing concurrent user-directed presentation and execution of normalised and Romanised, non-Roman and non-English function tokens within Excel, this invention provides a mechanism for billions of users to interact with the preeminent spreadsheet program on their terms, using their own terms. By providing ontological positions, banded cases and function tokens in a hierarchy, the categorisation and function token choices for translation from a default language to another provides a process where an unlimited number of native language function token sets can be developed and used with the Excel application as an add-in application component without reengineering the Excel applications

The invention in accordance with Description [10] provides a solution to the user of the Add-in application component for the concurrent display and execution of multiple language function token sets. Each individual language function token set is accessible independently of the operating system locale or Code Page.

The invention in accordance with Description [11] provides a solution to the user of the Add-in application component for the concurrent display and execution of multiple language, normalised and Romanised, function token sets. Each individual language, normalised and Romanised, function token set is accessible independently of the stipulated language of the installed Excel application.

The invention in accordance with Description [11] and [12] provides a solution to the user of the Add-in application component to have access to their own user-directed, normalised and Romanised, function token sets specifically designed to eliminate confusion and allow the user concentrate their attention on building their financial plans, models or performing bookkeeping tasks using terms from their own native language.

The invention in accordance with Description [10] provides a solution to the user of the Add-in application component for the concurrent display and execution of function tokens that have been normalised and Romanised during the translation process.

This invention, allows a person with programming experience to develop programmatic code for specific functional source code for function tokens. By utilising the inventions ontological hierarchy whilst accessing the Excel applications Visual Basic for Applications editor, or in a development environment for making COM dlls, a developer is able to manage (add/modify) code for each of the functional source code of the functions that have been or are developed and written by a developer in accordance with the ontology's design requirements. When complete, the functional source code for the function token sets are available for compilation into an Add-in application component. Any existing or new functional source code for functions can be added to the Add-in application component at any time using the Excel applications Visual Basic for Applications editor or the development environment for making COM dlls. All functional source code of the functions are named and positioned in accordance with the ontological hierarchy, providing ‘ontological positions’, ‘banded cases’ and ‘function tokens’ in a default language. When complete, all saved values are provided to the translator for processing through the User interface provides for translation to be completed for the new or amended function tokens within the function token set. Once complete, the newly added or modified functional source code of the functions and the translated function tokens are integrated into the add-in application component by compilation. The add-in application component then in turn makes the translations and the functional source code of the functions available to the application and ultimately the users.

All the function tokens (textual material written in a predefined default language and any translations of the said textual material) is being stored in a database of choice that is configurable through the invention's translator User interface. The invention includes programming code that enables a user to set the default user interface language as well as components used in the management of the translations and function tokens. The ontological positions are accessed through the User Interface. Each position can be chosen from a node point in the ontological hierarchy providing multiple language translation support [single and double byte character set (preferable UTF8) storage and sorting capabilities] in order to correctly manipulate the stored language translations.

The invention programmatically maintains structural integrity of all languages function token sets entered into the application automatically without requiring the user to contemplate the referential integrity of the normalised and Romanised function token sets. The function token set itself is completely designed and controlled by the ontological position in the hierarchy and is done so through the additions and amendments made and assigned to the default language only. Each normalised and Romanised function token is then made available for display and execution utilising the Excel applications Runtime Object Table (ROT) and hierarchy of permission.

The invention in accordance with Description [17] programmatically maintains structural integrity of all of the languages, normalised and Romanised function token sets entered into the user interface automatically without requiring the user to contemplate the referential integrity of the function token sets. The function token set itself provides the user with the ability to develop formulae in any of the available language function token sets at any time.

The invention in accordance with Description [17] programmatically maintains structural integrity of all languages entered into the application automatically without requiring the user to contemplate the referential integrity of the normalised and Romanised function token sets. The function token set itself provides the user with the ability to develop formulae in multiple language function token sets at any time.

The invention automatically maintains proper relationships between the function tokens within the ontology of function token sets that are written in default language and translated, normalised and Romanised, function tokens (written in any other language) so the ontology will always match regardless of number of additions or amendments of translations. When a normalised and Romanised function token is added or amended to default language, all translations of that record will be marked for amendment no mistranslations can occur. Also, before a translator completes any translator-defined additions or amendments through the user interface, the invention checks any omitted translations for existing records and notifies the translator before saving the new function token so the normalised and Romanised function tokens for a translation will always match the normalised and Romanised function token for default language. This verification process is vital for maintaining the integrity and accuracy of the function tokens in all languages

Once the normalised and Romanised function tokens (textual material) for the default language are finalized, a developer would integrate it into the add-in application component according to design requirements.

Based on the programming language used in the Excel application's Visual Basic for Applications editor, or the development environment for making COM dlls, the invention's functional source code for the function token sets would be made available to the programming interface for compilation, including the functions/methods and classes needed for implementation. By calling a method using configured parameters, it will allow a developer to pass the value to another function or display the result of the functional source code directly into the cell from which the function token is entered. For example when a function token (in Excel terms: SUM) is needed, a reference to the method of the functional source code for the function token is called (predetermined parameters must be entered) in any cell anywhere in the worksheet. The same procedure would apply for calling any other function token as many times as needed.

The invention in accordance with Description [16] programmatically maintains alternatives for every normalised and Romanised function token, in accordance with the ontology's design requirements. The alternative normalised and Romanised function tokens are truncations of function tokens that reside at nodes on the ontological hierarchy.

The invention in accordance with Description [23] programmatically maintains automatic truncation of default language normalised and Romanised function tokens as well as all of the translated normalised and Romanised language function token sets. This truncation process invokes each normalised and Romanised function token that resides at the root positions of the ontology. The truncated normalised and Romanised function tokens are numeric substitution of any translated, normalised and Romanised function tokens that are matched against the normalised and Romanised function token at root of each ontological function family. For example, for each normalised and Romanised function token that resides within the “Variant” family on the ontological hierarchy, the automatic creation process substitutes the normalised and Romanised function token component “Variant” with an integer.

The invention in accordance with Description [24] programmatically maintains automatic truncation with numeric substitution in an ever incrementing series. For example, as the first normalised and Romanised function token that resides within the “Variant” family on the ontological hierarchy, the “Variant” component of the normalised and Romanised function is substituted with the integer 1, and the second normalised and Romanised function token that resides within the “Variant” family on the ontological hierarchy, the “Variant” component of the normalised and Romanised function is substituted with the integer 2.

The invention in accordance with Description [25] programmatically maintains automatic truncation with numeric substitution that provides the eventual user with significantly shortened normalised and Romanised function tokens that invoke the same functional source code for the normalised and Romanised function token sets as the originating normalised and Romanised function tokens.

### Advantageous Effects

The invention in accordance with Description [25] programmatically maintains automatic truncation with numeric substitution that provides the eventual user with significantly shortened normalised and Romanised function tokens that invoke the same functional source code for the normalised and Romanised function token sets as the originating normalised and Romanised function tokens.

In order to maintain translation accuracy suitable for any professionally designed application and the ability to manage and display an unlimited number of languages, the invention leaves the actual translation process to an authorised translator while focusing its attention in the proper management of it the function tokens.

In order to maintain accuracy suitable for any professionally designed application and the ability to manage and display an unlimited number of programmatic codes for specific functional source code for normalised and Romanised function tokens, the invention leaves the actual development process to a sufficiently skilled developer while focusing its attention in the proper design and management of it the ontological hierarchy, banded cases and function tokens.

An example of the flexibility possessed by the invention resides in its ability to use the same internal Excel execution process for all of the language function token sets.

An example of the flexibility possessed by the invention resides in its ability to use the same user interface for translator interaction for each addition or amendment of the language normalised and Romanised function token sets, regardless of the language being translated.

An example of the flexibility possessed by the invention resides in its ability for the user to write formulae into the cells within any spreadsheet. The user has the ability to directly control the language of display and execution no matter which operating system version or Excel version after Excel 2003. The invention enables a native Portuguese user to use Portuguese normalised and Romanised function tokens when

using an English operating system and an English version of Excel. Normally, the user would only be able to use English function tokens within that environment.

An example of the flexibility possessed by the invention resides in its ability for the user to write brief formulae using truncated normalised and Romanised function tokens that have hierarchical significance provided by their position within ontological hierarchy.

This invention provides users from any country with normalised and Romanised function token sets from any natural non-Roman and non-English language, including those that are not representable in ANSI. The users have the ability to interact and control the most preeminent spreadsheet available on today's market, using function tokens based in their native language. The user can directly control the display and execution of normalised and Romanised function tokens that are symbiotic with their native language giving the user the ability to write formulae and think in their own language. As Excel dictates the language of display and execution, the user can dictate which language of the normalised and Romanised function token sets that wish to use. This removes several orders of magnitude of complexity from the user and provides a native language function token set for daily task at the click of a button. So creating financial plans, models or performing bookkeeping tasks with the program is easier and more understandable. The invention provides a controllable environment for the user for the first time.

This invention provides users from any country with normalised and Romanised function token sets. This normalisation and Romanisation is controlled by an orthographic convention that provides a trade-off for an unusual orthographic representation but familiar words are permitted for use within translated function tokens. Description of Drawings

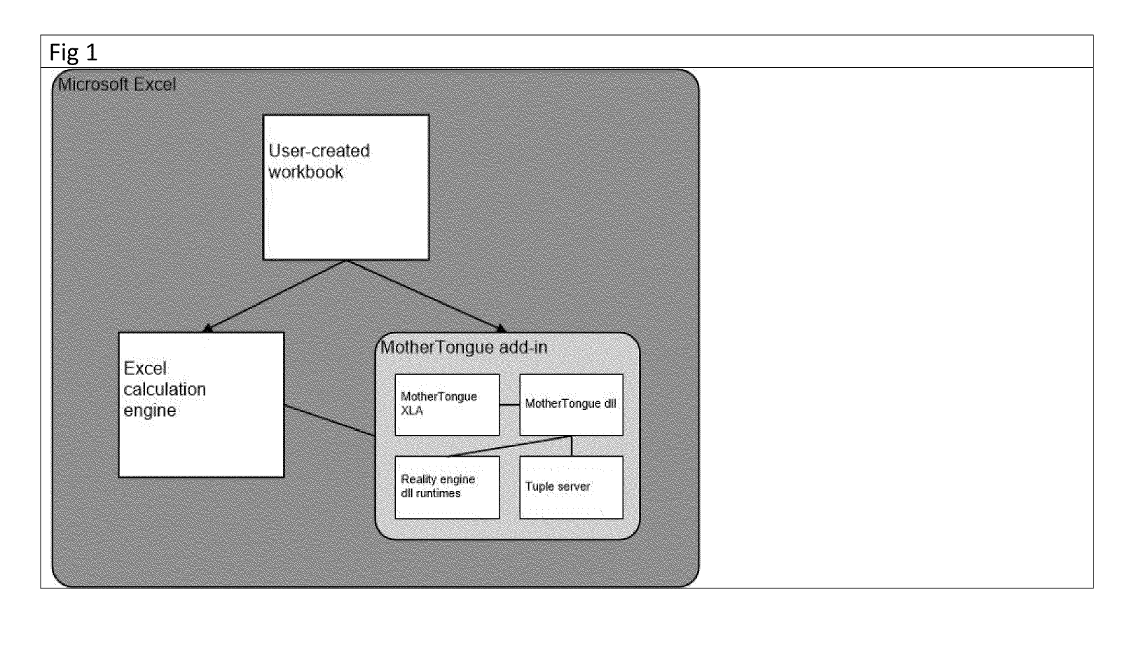

FIG. 1—Excel and Invention infrastructure's the formula is executed, the formula execution process will invoke the ROT, and evaluate any sub-expressions containing native Excel function tokens as well as any UDFs by invoking Excel's internal calculating engine or locating the UDF source code as stipulated by the formula execution process. It represents the schema for method's operation: See FIG. 1.

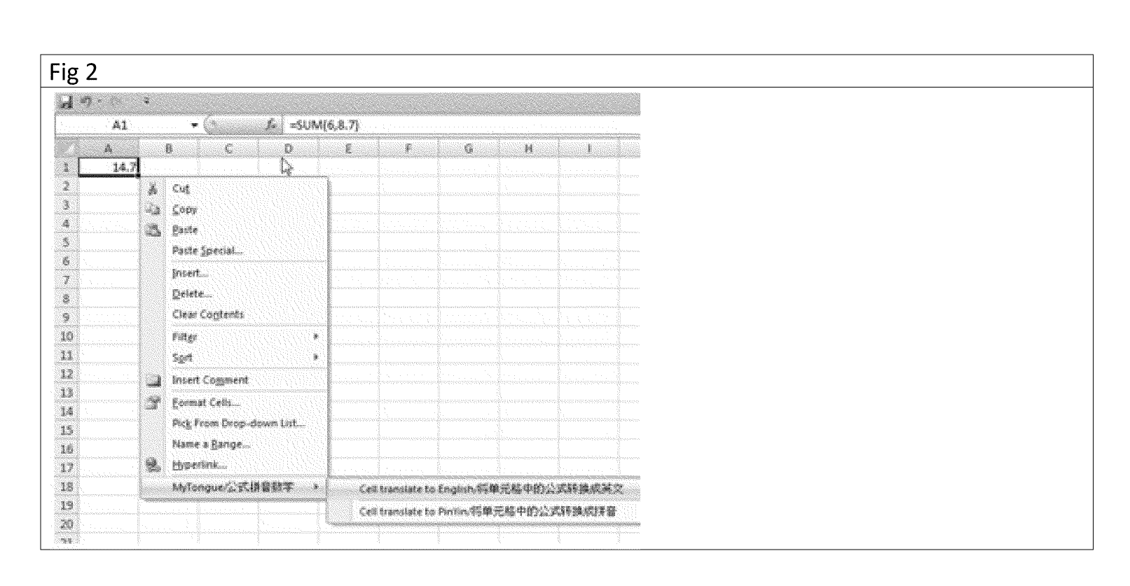

FIG. 2—Automatic Language function token translation. This method provides a process for the user-directed translation of the formulas in a cell by use of an in-context (or “right mouse”) menu which invokes the translation method. It is anticipated that the reader understands how to create an in-context menu item and invoke an event. The user-directed in-cell translation process operates by selecting a range of cells, and selecting a menu option from the context menu. There is a choice of directions for the two languages currently available. See FIG. 2

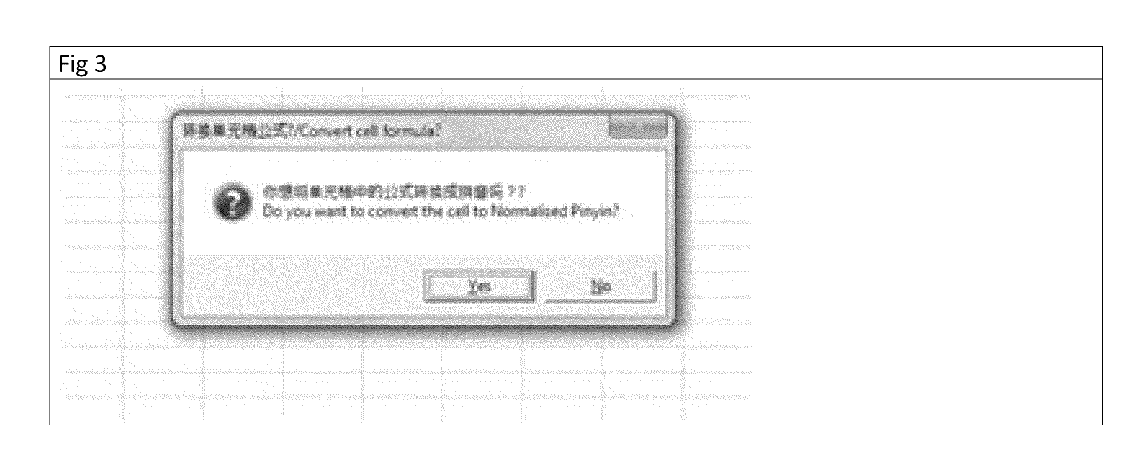

FIG. 3—Language function token translation confirmation. Depending on the direction of the translation selected, the user will get one of two dialogue boxes: On selecting Yes or pressing the Enter key, the cell translation process will be invoked, and the cell contents translated. Any UDF or otherwise unknown functions will be left alone and the other functions translated, and if an already translated formula is being retranslated, there will be no change to the formula. See FIG. 3

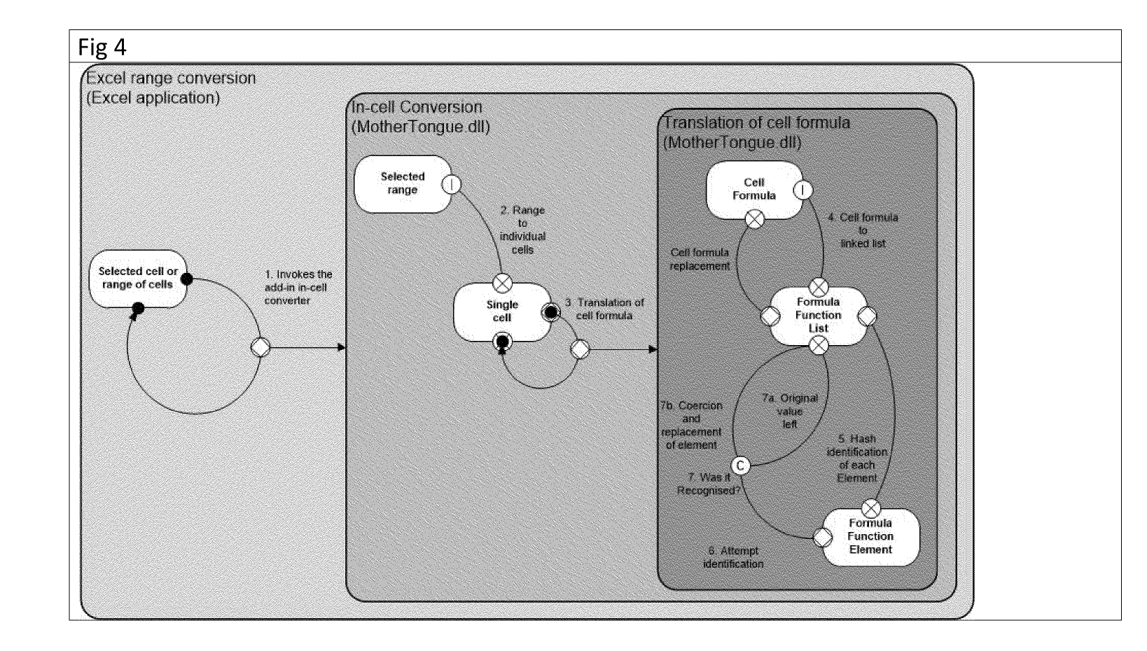

FIG. 4—Language function token translation confirmation. This user-directed in-cell translation function is affected by a real-time querying of a hashing table at a cell level. The hashing table consists of hashes of target values using the standard algorithm. This algorithm generates a unique number for all of the functions as a long integer. This long integer is then compared against the keys of a hash table. If no matching value is discovered, it is not replaced. Process Steps; As can be seen in the figure following;
1. Excel invokes the add-in in-call converter.
2. then the range is converted to a series of pointers to the cells
3. and then for each cell, the formula is translated
4. the formula is converted to a linked list
   1. the listed list is appraised for words that are bound on the left-hand side by an “=” or an opening parenthesis “(” and on the right-hand side or a closing parenthesis “)”
   2. for each found word, that word is entered into the linked list as a element
5. Each element in the linked list is then queried for identity with the hashing function
   1. In real-time, for each element in the list, a long integer key is derived using the hash algorithm
6. In real-time, each long integer key has a look up attempt is made within the hash table and;
7. if the attempt
   1. fails, the function token is left alone
succeeds, the identified long integer key is used to retrieve and
   2. translate the element in the linked list and back into the formulas. See FIG. 4

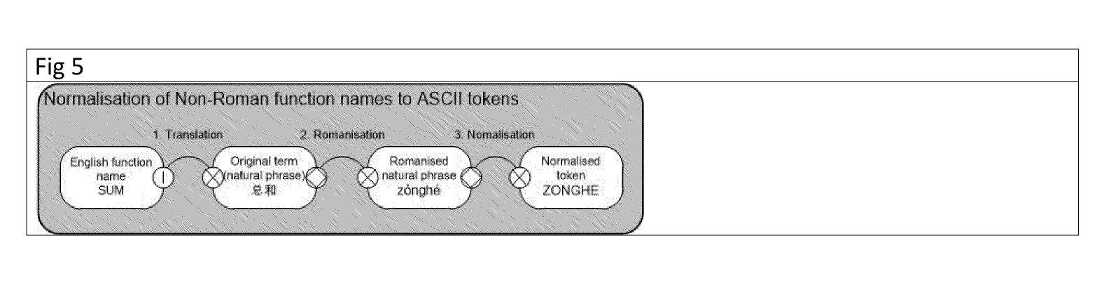

See FIG. 5 Creation of Multilingual non-ANSI function tokens for use within MS Excel Method of creating function tokens in any non-Roman and non-English natural language, including those that are not representable in ANSI.
A process of translatable replacement functions for every human language
   requires two sub processes
      Firstly, an orthographic convention is established to map any words or phrases in any language to ANSI standard characters
      Then a practical ontology of the function space, including the potentiality for expansion of functions, to situate the lexemes within a conceptual space that permits automated mapping to either native Excel functions or proposed function extensions. This is to done to ensure a consistent representation across all languages.
   The orthographic convention requires a new process to be developed. This process (we have called Normalised Romanisation). The following steps are executed on
      Individual Words:
         all distinguishing tone-marking are removed
         all orthographic diacritic markers are removed
         the results made entirely uppercase.
      Phrases of Words:
         11 distinguishing tone-marking are removed.
         all orthographic diacritic markers are removed.
         spaces are dropped from the phrases.
         the results made entirely uppercase.
      This orthographic convention provides a trade-off for an unusual orthographic representation but familiar words are permitted for use within formula expressions. The process can be seen in this FIG. 5, using the SUM function and Mandarin Chinese as examples: See FIG. 5

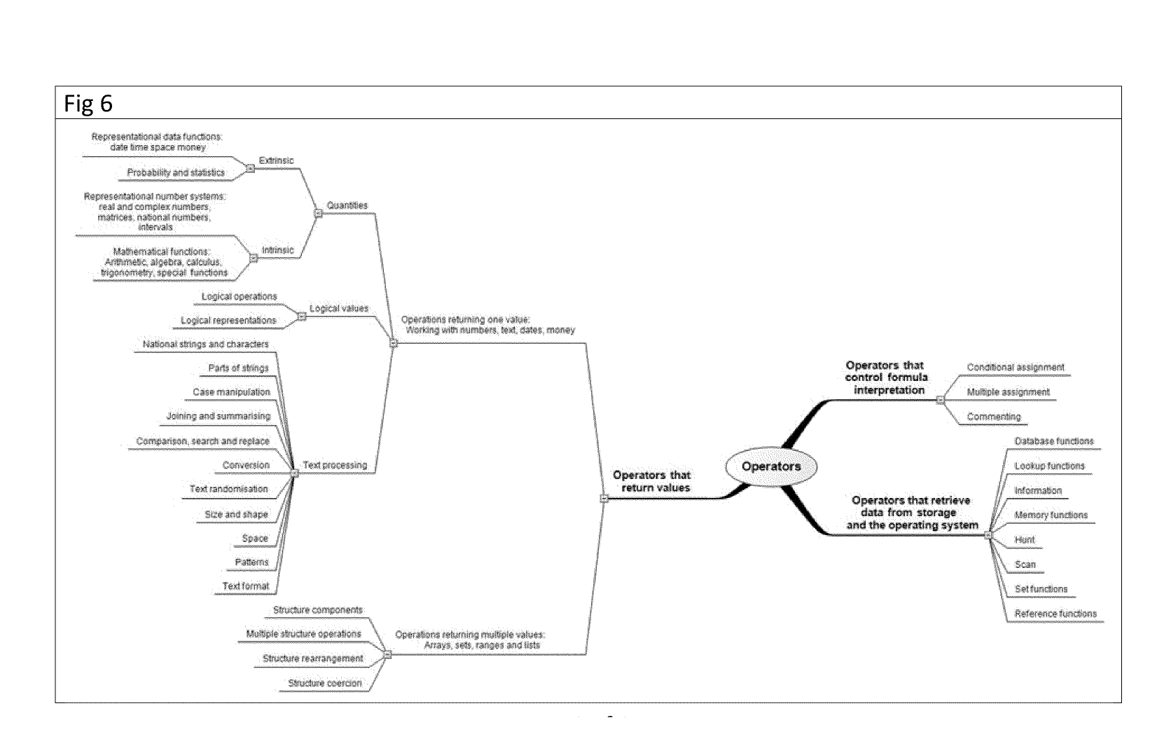

See FIG. 6 Ontological hierarchy, An expandable hierarchical Bunge-Wand-Weber style ontology was created to situate the existing Excel formula functions (both standard functions and those belonging to the Microsoft Analysis Tool-pack add-in) together with an expansion set of 888 extra functions contained within the invention. See FIG. 6

These ontological locations were encoded and the encodings used to create an English candidate term-set, which is the basis for the term-normalisation.

To achieve a normalised set of tokens for functions, the ontology is used to construct candidate sets which are then examined by an experienced human polyglot translator. Subsequent to this examination automated tests for formulaic ambiguity as well as manual social inappropriateness tests which can modify the candidate set is run until a set of satisfactory tokens (having no ambiguity or inappropriateness) is achieved.

To test this mechanism, a series of translated lexicons was chosen for several languages from different language families, and then the process run on them. This was carried out on candidate languages Mandarin, Chinese, Hindi and Urdu, and well as lesser diacritically figured languages including German, Japanese and French, and simple languages Malay and Indonesian.

This normalisation can be seen in the following transforms:

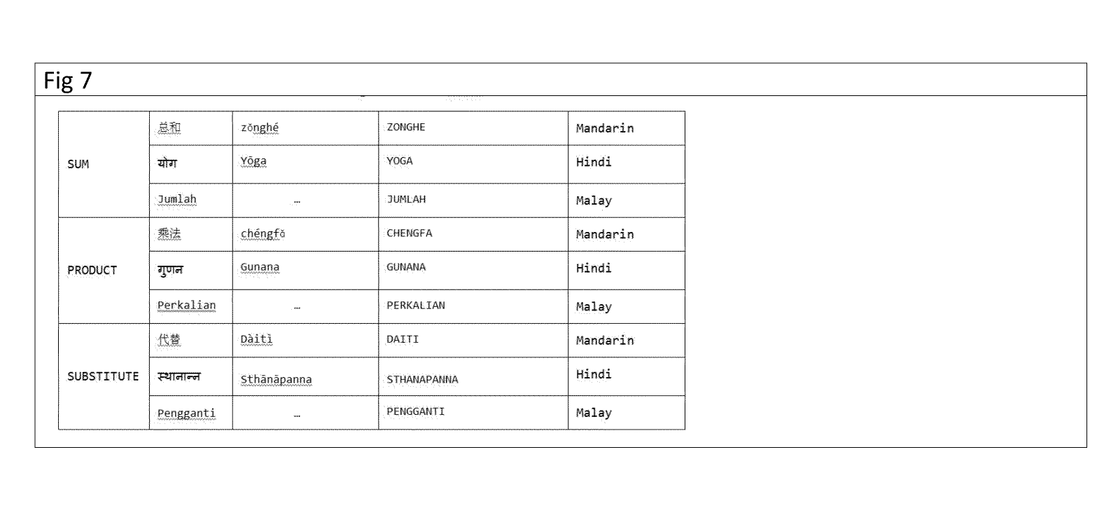

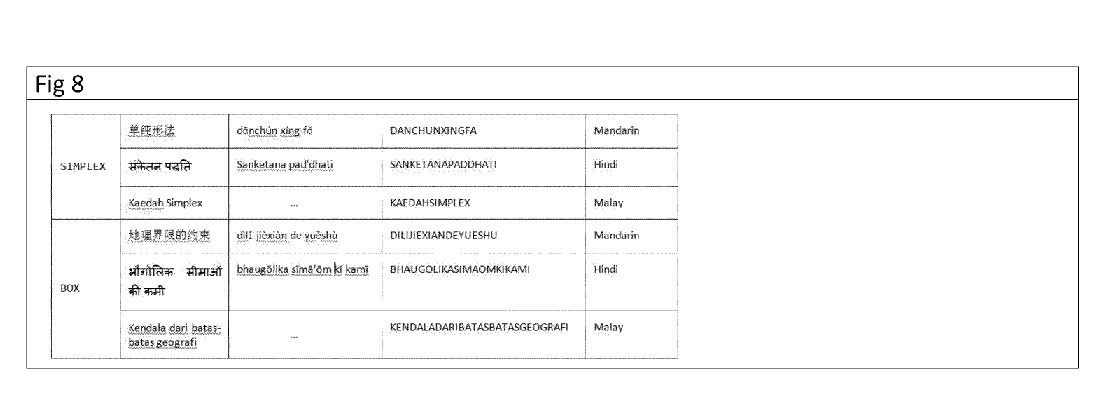

See FIG. 7, This process (ontological situating and automatic term generation) was tested by extending the standard and add-in Excel functionality by adding a further 888 functions to the core Excel function set with the same result: These extra functions extend Excel to create a seamless greater function set in both the original Excel functions and the extensions. The results of the analysis show that without ambiguity, a set of tokens for 9 cross-language function- and function-family-names could be developed that would permit the establishment of an alternative macro formula set in Microsoft Excel. See FIG. 8

### BEST MODE

Having separated the normalised function tokens to be used for the Expression functions and their parameters, a method must be established for automatic creation of the source-code, which has to be created uniquely for each language function set.

The function source code necessary to run the Excel Expression function calls is taken, unique identifiers are established for each of the names and parameter names, and then a variant on the original source code, called the vanilla source version, is made with the unique identifiers in place of the function tokens.

These vanilla source versions are stored in a database preparatory to creating the code trees. There are two separate source trees to be constructed, those in the XLA add-in and those in the source for the COM DLL object.

A separate table exists for the normalised tokens for each language, and there is an intersection table for identifying the tokens used with the vanilla source entry. Iteration of an inner join query produces the source code to be output to the two targets, creating the source files automatically.

Rather than accessing the data directly, the translator employs a purpose-built application that retrieves the data for the language set and function set on which he/she is operating. This permits the automatic Romanisation and normalisation of the candidate word, and automatic verification of the tokens as per [FIG. 5] above. Having the user interface directly access the database as storage, will enable the translator to maintain perfect alignment for each translation without the possibility of ambiguity or confusion.

The same database is accessed by the developer for a separate set of operations, to permit additional functions to be added to the Add-in and thereby presented to the translators for each language set.

For each language set the developer adds to the runtime menu for Excel the invocation of the token set and its inter-translation via the context (right mouse) menu. This is achieved by attaching a method to the start-up of the DLL object itself. This means that the COM cannot be invoked outside of the Excel COM/Add-in infrastructure.

Having the ontological hierarchy clearly defined and mapped out will enable the developer to position the function tokens at the correct ontological positions, and to create the relevant banded cases for storage and execution of the functional source code for function tokens.

In order to better understand the process we have included the ontological hierarchy in which FIG. 6 contains the relationships between the function token families and the function tokens at the root of each family.

The first thing to notice with reference to 47, is a function token family will always have the same characteristics: there will be variation on the main characteristic but fundamentally that will perform in similar ways. That is why they have been categorised into the family.

Function token choice must utilise the double entries removal process so no ambiguity is possible within the function token set. As this invention makes use of Excel's ROT, any duplication of function tokens will cause ambiguity, which gives priority to the first encountered entry. When the Invention is loaded on a system whereby Excel is presenting a non-English token set, the MotherTongue functions of the same name will not be loaded, or will be loaded and given lower priority, so ambiguity will not arise

### INDUSTRIAL APPLICABILITY

The invention presents the non-English speaking user of spreadsheets with familiar words in the formula bar of Excel, a software so ubiquitous in industry that it can be considered as vital to the modern office. Providing the offices of the non-English speaking world with an alternative path into the functionality of Excel, independent of the operating system or locale in which they are working, is therefore something that will manifestly increase productivity and accountability for all manner of professional activities and extend the range of functional use, but will also serve for the needs of scientific and agronomic event recording (for scientific experiments and crop yield recording respectively). It will be a boon to any situation where information has to be recorded and analysed.

1. Concurrent ad-hoc user-directed multi-language function token set management, display and execution application within Excel comprising: code for ad-hoc user-directed, concurrent presentation and execution of function tokens; code for allowing user to directly control the display and execution of the language of the function tokens in an ad-hoc manner, independent of the locale and Code Page of the operating system; an ontology for developing the function token hierarchical relationships and position; code for developing the functional source code for the function token sets; code for accessing the function token set functional source code, code for transfer of translator-defined function token sets into Excel for the purpose of displaying and executing the function tokens; code for managing translator-defined function token sets; code for import/export translations of translator-defined function token sets; and code for managing relational database storage needs and enforcement of referential integrity methods of the function token sets;

2. Concurrent ad-hoc user-directed multi-language function token set management, display and execution of add-in application component within Excel in accordance with claim 1, wherein said translator-defined function token set comprises text entered and/or verified by said translator through a user interface following an automated function token set development process;

3. Concurrent ad-hoc user-directed multi-language function token set management, display and execution of add-in application component within Excel in accordance with claim 2, wherein said translator comprises a person responsible for administration of translator-defined function token sets within Excel;

4. Concurrent ad-hoc user-directed multi-language function token set management, display and execution of add-in application component within Excel in accordance with claim 3 wherein Excel comprises an add-in application component enabled to display and execute function tokens in multiple languages, concurrently by integrating the multiple language management, display and execution application as part of it;

5. Concurrent ad-hoc user-directed multi-language function token set management, display and execution of add-in application component within Excel in accordance with claim 1, the said developer describes an ontological map of the function tokens for a hierarchical relationship and positioning of function tokens with function families;

6. Concurrent ad-hoc user-directed multi-language function token set management, display and execution of add-in application component within Excel in accordance with claim 2, the said automated function token set development process comprises the location, translation, addition, amendment and verification of the function token sets;

7. Concurrent ad-hoc user-directed multi-language function token set management, display and execution Add-in application component within Excel in accordance with claim 6, the said automated function token set development process consists of a process where the said translator locates and translates each function token through a user interface. Each individual translated function token is then entered into a user interface according the relevant original function token;

8. Concurrent ad-hoc user-directed multi-language function token set management, display and execution of add-in application component within Excel in accordance with claim 7, the said translator reviews the function token set for ambiguity and the said translator substitutes any identified function tokens;

9. Concurrent ad-hoc user-directed multi-language function token set management, display and execution of add-in application component within Excel in accordance with claim 6, the said automated function token set development process comprises the auto creation of a normalised version of the translated function token set;

10. Concurrent ad-hoc user-directed multi-language function token set management, display and execution of add-in application component within Excel in accordance with claim 9, the said automated function token set development process comprises automatic notification of any existence of double entries in normalised version and the said translator substitutes any identified function tokens with new relevant entries;

11. Concurrent ad-hoc user-directed multi-language function token set management, display and execution of add-in application component within Excel in accordance with claim 10, the said automated function token set development process comprises automatic notification of any existence of taboo words in existing relational database table for substitution the said translator substitutes any identified function tokens with new relevant entries;

12. Concurrent ad-hoc user-directed multi-language function token set management, display and execution of add-in application component within Excel in accordance with claim 11, the said automated function token set development process comprises automatic notification of any existence of double entries in taboo-removed normalised version and the said translator substitutes any identified function tokens with new relevant entries;

13. Concurrent ad-hoc user-directed multi-language function token set management, display and execution of add-in application component within Excel in accordance with claim 5, the said automated function token set development process comprises automatic creation of truncated function tokens by abbreviating any translated function tokens that are matched against the function token at root of each function family;

14. Concurrent ad-hoc user-directed multi-language function token set management, display and execution of add-in application component within Excel in accordance with claim 13, the said automated function token set development process comprises automatic notification of any existence of double entries in truncated normalised version and the said translator substitutes any identified function tokens with new relevant entries;

15. Concurrent ad-hoc user-directed multi-language function token set management, display and execution of add-in application component within Excel in accordance with claim 3 wherein the said developer comprises the developer-defined programmatic code of the Add-in application component to be executed by the Excel application;

16. Concurrent ad-hoc user-directed multi-language function token set management, display and execution of add-in application component within Excel in accordance with claim 15 wherein the said developer-defined programmatic code is written to utilise the Excel applications Runtime Object Table (ROT) and hierarchy of permission;

17. Concurrent ad-hoc user-directed multi-language function token set management, display and execution of add-in application component within Excel in accordance with claim 16 wherein the code is written to access ROT is used to provide concurrent display and execution of multiple language function token sets, independent of the locale and Code Page of the operating system;

18. Concurrent ad-hoc user-directed multi-language function token set management, display and execution of add-in application component within Excel in accordance with claim 16 wherein the code is written to provide the user to directly control the language of the function tokens in an ad-hoc manner, independent of the locale and Code Page of the operating system;

19. Concurrent ad-hoc user-directed multi-language function token set management, display and execution of add-in application components within Excel in accordance with claim 16 wherein the code for each of the functional source code of the functions are developed and written in the Excel applications Visual Basic for Applications editor as well as in a development environment for making COM dlls;

20. Concurrent ad-hoc user-directed multi-language function token set management, display and execution of add-in application component within Excel in accordance with claim 16 and claim 1 wherein the code is written for each function token;

21. Oncurrent ad-hoc user-directed multi-language function token set management, display and execution Add-in application component within Excel in accordance with claim 1 wherein the translation of translator-defined function token sets comprises the recollection of translator-defined function token sets stored as the default language and displayed within the user-interface for the purpose of translating it;

22. Concurrent ad-hoc user-directed multi-language function token set management, display and execution of add-in application component within Excel in accordance with claim 1 wherein import translation of translator-defined function token sets comprises the import of same external file in accordance with claim 5 containing the fully translated function token sets into an add-in application component;

23. Concurrent ad-hoc user-directed multi-language function token set management, display and execution of add-in application component within Excel in accordance with claim 1 wherein managing relational database storage needs comprises an interface where said translator can select the database software used as storage for the saved (entered or imported) function token sets, the creation, modification or deactivation of database records used to store the said translator-defined function token sets;

24. Concurrent ad-hoc user-directed multi-language function token set management, display and execution of add-in application component within Excel in accordance with claim 1 wherein enforcement of referential integrity methods comprises the tracking of identification records and accurately maintain relationships within records in accordance with referential guideline;

25. Concurrent ad-hoc user-directed multi-language function token set management, display and execution of add-in application component within Excel in accordance with claim 1 wherein code for transfer of translator-defined function token sets comprises an interface capable of programmatically communicating with the Add-in application component within Excel for the purpose of compiling the requested function token sets into it;

26. Concurrent ad-hoc user-directed multi-language function token set management, display and execution of add-in application component within Excel in accordance with claim 1 wherein change of the function token language comprises a selection made by a user of the Add-in application component within Excel from a list of available default or translated function tokens with the purpose of changing the function token in which the concurrent display and execution of the function tokens is translated;

27. A method for the separation of function tokens sets in the Add-in application component comprising: collection, storage, retrieval and display of translator-defined function tokens sets using ontological positions, banded cases and function tokens;

28. The method for the separation of function tokens sets in accordance with claim 27 wherein the said translator-defined function tokens sets comprises textual material written in a language set as default by said translator and an unlimited number of translations of same material;

29. The method for the separation of function tokens sets in accordance with claim 28 wherein the said unlimited number of translations comprises the translation of textual material in an unlimited number of distinct languages;

30. The method for the separation of function tokens sets in accordance with claim 27 wherein the said ontological positions, banded cases and function tokens comprises an enumeration of textual material stored together as a group for concurrent display and execution;

31. The method for the separation of function tokens sets in accordance with claim 27 wherein the said function tokens comprises single entities of textual material containing from one word to one phrase that are saved and displayed independently from other function tokens;

32. The method for the separation of function tokens sets in accordance with claim 27 wherein the said ontological positions, banded cases and function tokens of translator-defined content comprises the use of ontological positions, banded cases and function tokens in all aspects of management and concurrent execution of translator-defined function tokens sets, from the ontology the automated function token set development process through until the usage, display and execute by the user interaction;

33. A method for the creation of relationships between records written in default language and records written in a foreign language comprises:
code for creation of necessary identification columns; code for assigning identification numbers for records written in default language; creation of a unique identification number for the transfer of characteristics from records written in default language to records written in foreign language;

34. The method for the creation of relationships between records in accordance with claim 33 wherein said record written in a foreign language comprises a record storing the translation of a record written in default language and the textual material is written in a foreign language;

35. The method for the creation of relationships between records in accordance with claim 33 wherein said default language comprises a language chosen by an administrator of Excel to be the default displaying language for the said translator-defined function token sets;

36. The method for the creation of relationships between records in accordance with claim 33 wherein said foreign language comprises a language other than default language;

37. The method for the creation of relationships between records in accordance with claim 33 wherein said code for creation of ID columns comprises the creation of four ID columns for each table containing records written in multiple languages as follow: first ID represents an auto-number column whose values are assigned automatically by the database software and are always unique; second ID column stores the hierarchical positioning of function families, providing root positions for each family; third ID column stores same value found in first ID column for records written in default language and for translation records (written in any foreign language), the value will be that of the first ID column the record is a translation of; fourth ID column stores the ID of the language the record is written into;

38. The method for the creation of relationships between records in accordance with claim 37 wherein said third ID column comprises a field storing a numeric value used to create relationships between records written in default language and their respective translations (written in any foreign language); records having same third ID and written in a foreign language (written language is determined through fourth ID) are translations of record written in default language;

39. The method for the creation of relationships between records in accordance with claim 33 wherein code for assigning identification numbers to records written in default language comprises the transfer of first ID column in accordance with claim 37 to third ID column and transfer of default language ID to fourth ID column anytime the record is modified;

40. The method for the creation of relationships between records in accordance with claim 33 wherein code for transfer of characteristics from records written in default language to records written in foreign language comprises two steps: a) the export into an external file of all records written in default and their translation in a chosen foreign language (if present) for the purpose of translating them; and b) the import of same external file containing both default language and translated foreign language records into the storage database;

41. The method for the creation of relationships between records in accordance with claim 40 wherein external file comprises a text file containing all textual material saved and used in the Add-in for Excel for the default language and chosen foreign languages saved in an unlimited amount of separate columns;
